(19) United States
(12) Patent Application Publication
(10) Pub. No.: US 2009/0039542 A1
(43) Pub. Date: Feb. 12, 2009

(54) METHOD OF AND APPARATUS FOR MAKING PACKING TAPE

(76) Inventor: Jurgen Morton-Finger, Weinheim (DE)

Correspondence Address: K.F. ROSS P.C., 5683 RIVERDALE AVENUE, SUITE 203 BOX 900, BRONX, NY, 10471-0900, US

(21) Appl. No.: 12/189,234

(22) Filed: Aug. 11, 2008

(30) Foreign Application Priority Data
Aug. 10, 2007 (EM) 07015742.5

(51) Int. Cl. B29C 47/10

(52) U.S. Cl. 264/176.1; 264/210.2; 425/325

(57) ABSTRACT

Packing tape is made by predrying polyethylene terephthalate and supplying it to an intake end of a chamber of an extruder where the polyethylene terephthalate is agglomerated and melted while being moved through the chamber in a travel direction. Negative pressure is applied to the chamber of the extruder and to degas the PET and thereby draw low-molecular-weight impurities from the polyethylene terephthalate therein, and extruding the melted polyethylene terephthalate as a strip from the extruder through a spinneret.

### FIELD OF THE INVENTION

The present invention relates to packing tape. More particularly this invention concerns a method of and apparatus for making packing tape from recycled polyethylene terephthalate.

### BACKGROUND OF THE INVENTION

PET scrap is normally shredded PET, especially shredded used PET bottles. In particular, this shredding produces so-called PET flakes that are preferably used according to the invention. PET scrap is more cost-effective than virgin PET material or virgin PET granulate. On the other hand, PET scrap is also distinguished by significant disadvantages. PET scrap initially has a relatively high degree of impurities. Furthermore, PET scrap has a relatively high moisture content. In addition, PET scrap is present in an amorphous form.

EP 1 440 783 A1 [US 2004/0164437] describes supplying PET material, in particular PET scrap, to a twin-screw extruder without pre-drying and without pre-crystallization. The produced molten plastic is outputted as a strip by a spinneret that is downstream of the twin-screw extruder. The cooled and stretched plastic strips are used for packing tape. This known method has been proven.

Several methods for processing PET scrap are known from practice. These methods are disadvantageous due to the fact that the impurities contained in the PET scrap are at least largely left in the end product. As a rule, these impurities from the PET scrap lead to lower quality for the PET products produced. These impurities are in particular adhesives, chemical additives, and the like.

### OBJECTS OF THE INVENTION

It is therefore an object of the present invention to provide an improved system for making packing tape from PET scrap.

Another object is to provide an improved method of and apparatus for doing this that produces a packing tape that has higher quality with optimum properties, in particular with excellent mechanical properties.

### SUMMARY OF THE INVENTION

Packing tape is made according to the invention by predrying polyethylene terephthalate and supplying it to an intake end of a chamber of an extruder where the polyethylene terephthalate is agglomerated and melted while being moved through the chamber in a travel direction. Negative pressure is applied to the chamber of the extruder and to degas the PET and thereby draw low-molecular-weight impurities from the polyethylene terephthalate therein, and extruding the melted polyethylene terephthalate as a strip from the extruder through a spinneret.

According to the invention low-molecular-weight impurities are in particular substances that result from the materials with which the PET scrap is contaminated, for instance adhesives, chemical additives, and the like. According to the invention low-molecular-weight impurities does not mean the residual water that may still be contained in the pre-dried PET scrap. Naturally, any residual water still present can be removed at the same time the low-molecular-weight impurities are removed with the applied negative pressure. The object of the invention, however, is to remove from the PET scrap the low-molecular-weight impurities that are not water.

According to the invention the fact that PET scrap is used or is extruded with the single-screw extruder also includes embodiments in which virgin PET material or virgin PET granulate is mixed with the PET scrap. According to the invention PET scrap means that the material comprises at least 50 wt. %, preferably at least 75 wt. %, more preferably 85 wt. %, and very preferably at least 90 wt. % PET scrap or PET recycled material. According to the recommended embodiment of the invention, the PET material used comprises at least 95 wt. % PET scrap or entirely comprises PET scrap or almost entirely comprises PET scrap. It is particularly within the scope of the invention that the inventively used PET scrap derives from used PET bottles. Preferably these used PET bottles are shredded so that so-called PET flakes result that are preferably used in the inventive method. It is moreover within the scope of the invention that PET scrap can derive from used PET films.

In accordance with the invention, pre-dried PET scrap is used and supplied to the single-screw extruder and is extruded with the single-screw extruder. According to a preferred embodiment of the invention, the pre-dried PET scrap has a moisture content or a water content of less than 35 ppm, preferably less than 30 ppm and more preferably less than 25 ppm. It is within the scope of the invention that the moisture content or water content of the pre-dried PET scrap be between 10 to 30 ppm, preferably ranging from 10 to 25 ppm.

In accordance with one embodiment, the pre-dried PET scrap is supplied to the single-screw extruder using at least one doser that is embodied for instance as a metering screw. Such a special doser is not absolutely necessary according to the invention however. The PET scrap can also be supplied to the single-screw extruder directly from a funnel system. The PET scrap is preferably supplied to the single-screw extruder in the form of PET particles, more preferably in the form of PET flakes. In accordance with one embodiment, PET particles also means PET granulate.

It is within the scope of the invention that the negative pressure is produced in the extruder chamber or the degassing of the extruder chamber is performed using at least one pump or vacuum pump that is connected to the extruder chamber. It is furthermore within the scope of the invention that a negative pressure of less than 10 millibars, preferably less than 5 millibars, more preferably less than 3 millibars, be applied to the extruder chamber. In accordance with a very preferred embodiment of the invention, the negative pressure applied to the extruder chamber ranges from 1 to 10 millibars, preferably from 1 to 5 millibars, and very preferably from 1 to 3 millibars.

The negative pressure in the extruder chamber is preferably produced by one to three vacuum domes spaced longitudinally along the single-screw extruder. According to a highly recommended embodiment of the invention, for making the negative pressure in the extruder chamber there are at least two longitudinally spaced vacuum domes on the single-screw extruder. In accordance with one particularly preferred embodiment of the invention the negative pressure is applied and the single-screw extruder is degassed for removing the low-molecular-weight impurities both in the agglomerate zone of the extruder and in the melt zone of the extruder. The agglomerate zone of the extruder is the zone in which the supplied PET particles, in particular PET flakes, bind and create agglomerates, but are not yet completely melted. In this agglomerate zone in particular a softening or melting occurs on the surfaces of the PET particles/PET flakes so that agglomeration results. The temperature in the agglomerate zone of the single-screw extruder is 140 to 160° C., preferably 150° C. or about 150° C. In terms of the length of the extruder chamber, the agglomerate zone is provided at least in part in the upstream half of the extruder chamber. The PET is preferably fully or mostly melted in the melting zone of the single-screw extruder. In terms of the length of the extruder chamber, the melting zone is in the downstream half of the extruder chamber. Thus the degassing of the extruder chamber preferably is done by at least one vacuum dome connected to the agglomerate zone of the single-screw extruder and by at least one vacuum dome connected to the melting zone of the single-screw extruder. The negative pressure specified above is preferably applied to each of these vacuum domes.

It is within the scope of the invention that during the inventive degassing of the extruder chamber at least one low molecular impurity or substance from the group “glycol, 1,2-ethane diol, dioxolan, xylene, ethanol, terephthalic acid, isophthalic acid, acetaldehyde, 2-propanol” is removed from the extruder chamber by applying negative pressure. The method is preferably conducted such that at least two or three of the above-described impurities are removed from the extruder chamber. According to the invention dioxolan means in particular 2-methyl-1,3-dioxolane. Xylene means in particular m-xylene and/or p-xylene. It is furthermore within the scope of the invention that the method is conducted such that during the degassing of the extruder chamber cyclic oligomers with the formula (COC₆H₄COOCH₂CH₂)ₓ are removed, where x=3-13. Preferably primarily a cyclic oligomer with x=3 is removed from these oligomers. Low-molecular-weight impurities means in particular also low molecular weight PET portions (oligomers) that result as the balance from the splitting during a polyester hydrolysis.

According to a very preferred embodiment of the invention a screen filter is downstream of the single-screw extruder. One particularly recommended embodiment of the invention is characterized in that the melting pressure in the travel direction is measured upstream of the screen filter and downstream of the screen filter and the speed of the single-screw extruder and/or the infeed rate of the PCT scrap to the single-screw extruder is varied as a function of the pressure values measured. The metering of the PET scrap can be changed for instance by adjusting the speed of a metering screw that is upstream of the single-screw extruder. Pressure regulation is especially helpful when rinsing the screen filter. A backwash system is preferably provided and, depending on how dirty the screen filter is, the melt is discharged into the open in order to rinse foreign matter from the screen. During the rinse process the single-screw extruder requires additional material for a brief period. This backwash can be performed with no problem using the inventive pressure regulation.

The plastic strip exiting from the spinneret advantageously has a width of 3 mm to 50 mm. It is within the scope of the invention that the plastic strip extruded from the spinneret is then cooled and stretched. The plastic strip is advantageously cooled with a liquid medium, preferably in a water bath. The plastic strip is preferably stretched in at least one stretching direction. The plastic strip is preferably stretched in a plurality of stretching directions.

The invention furthermore relates to an apparatus for making a packing tape of polyethylene terephthalate (PET), a drying device for pre-drying PET scrap being provided, a single-screw extruder being present with which the pre-dried PET scrap can be extruded, the single-screw extruder having at least one vacuum dome for applying negative pressure to the extruder chamber and for removing low-molecular-weight impurities from the PET scrap, and furthermore a spinneret being provided downstream of the single-screw extruder and outputting the molten plastic (PET) in a strip shape.

It is within the scope of the invention that at least one crystallizer is used as a drying device. The PET scrap is pre-dried and pre-crystallized in the crystallizer.

The invention is based on the understanding that it is possible to produce high-quality packing tape from relatively low-cost PET scrap using the inventive method. The invention is based above all on the understanding that the impurities contained in the PET scrap can have a significant negative effect on the quality of a packing tape produced therefrom. This is true principally for the mechanical properties of such a packing tape. With the inventive measures it is possible to produce a packing tape that is distinguished by optimum mechanical properties, specifically in particular by excellent strength and optimum elongation properties. In addition, using the inventive method and using the inventive device it is possible to produce the packing tape in a manner that is relatively simple, not very complicated, and therefore cost-effective.

### BRIEF DESCRIPTION OF THE DRAWING

The above and other objects, features, and advantages will become more readily apparent from the following description, reference being made to the accompanying drawing in which:

FIG. 1 shows a device for performing the inventive method; and

FIG. 2 shows an enlarged detail from FIG. 1.

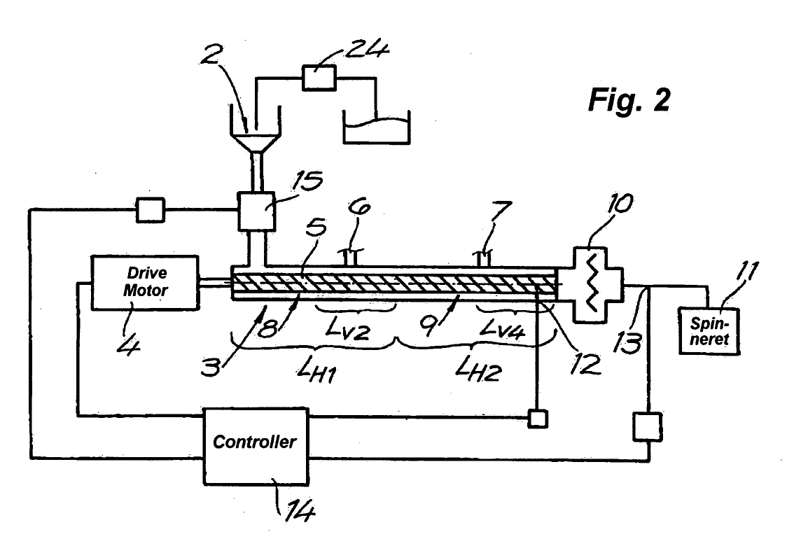

### SPECIFIC DESCRIPTION

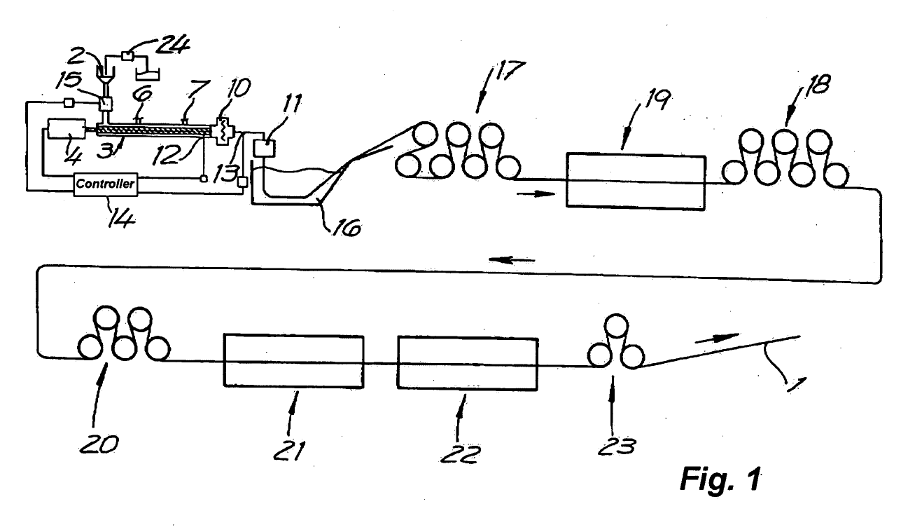

As seen in FIG. 1 PET scrap is used for making a packing tape 1. It is recommended that the PET scrap be used in the form of PET flakes 2 that were preferably obtained by shredding used PET bottles. The PET scrap or the PET flakes are advantageously and in the illustrated embodiment pre-dried and pre-crystallized in a drying device or crystallizer 24. Then the pre-dried PET particles or PET flakes 2 are supplied to a single-screw extruder 3 with which the PET scrap is extruded. The single-screw extruder 3 is driven by an extruder motor 4.

During extrusion of the PET scrap, negative pressure is applied to the extruder chamber 5 of the single-screw extruder 3 such that low-molecular-weight impurities are removed from the PET scrap. The negative pressure is preferably less than 10 millibars absolute, more preferably less than 5 millibars absolute, and very preferably less than 3 millibars absolute.

In accordance with a very preferred embodiment, and in the illustrated embodiment, the negative pressure in the extruder chamber is produced using two vacuum domes 6 and 7 that are spaced longitudinally along the single-screw extruder 3. The upstream vacuum dome 6 is connected to the agglomerate zone 8 of the single-screw extruder 3, where the PET flakes 2 agglomerate with one another without melting completely. The downstream vacuum dome 7 is connected to the melting zone 9 of the single-screw extruder 3, where complete or at least nearly complete melting of the PET flakes 2 has taken place.

In the illustrated embodiment, the upstream vacuum dome 6 is connected to the upstream longitudinal half L_{H1} of the extruder chamber 5 in terms of the longitudinal extent of the extruder chamber 5 and preferably in the second longitudinal quarter L_{V2} of this extruder chamber 5. In terms of the length of the extruder chamber 5, and in the illustrated embodiment, the downstream vacuum dome 7 is preferably connected to the downstream longitudinal half L_{H2} of the extruder chamber 5 and preferably in the furthest downstream or longitudinally last third or quarter L_{V4} of the extruder chamber 5. At least one vacuum pump (not shown in the figures) is advantageously connected to the vacuum domes 6 and 7. It should be stressed that due to the inventive degassing the low-molecular-weight impurities are removed from the PET scrap.

A screen filter 10 is downstream of the single-screw extruder 3. Downstream of the screen filter 10, the PET melt is supplied to a spinneret 11, from which the PET melt exits in a flat strip. The melt pressure is preferably measured at an upstream measuring point 12 upstream of the screen filter 10 and at a downstream measuring point 13 downstream of the screen filter 10. A controller 14 can adjust the speed of the single-screw extruder 3 on the extruder motor 4 depending on the measured pressure values and/or to control intake of the PET scrap using a doser 15 upstream of the single-screw extruder 3.

Initially, PET that is still molten exits from the spinneret 11 in a strip and is then cooled. To this end, the plastic strip workpiece is advantageously conducted through a water bath 16 having a temperature preferably ranging between 30 and 90° C., more preferably 40 to 80° C., and very preferably of about 60° C.

Then it is recommended that the plastic strip be stretched and to this end it is conducted through an upstream stretcher 17. The stretcher 17 can work for instance at an advance speed of 15 m/min. Then the plastic strip is advantageously conducted through a downstream stretcher 18 that works for instance at an advance speed of 60 m/min. The plastic strip is thus stretched longitudinally or in the travel direction between the stretchers 17 and 18. The plastic strip is conducted through an oven 19 in which it is heated, specifically preferably above glass transition temperature. Following this the plastic strip is preferably guided through a third stretcher 20 that works for instance at an advance speed of 90 m/min. Between the stretchers 18 and 20 the plastic strip is again stretched longitudinally or in the travel direction.

Then the plastic strip is advantageously conducted through a fixer 21 in which it is heated. Subsequently as recommended the plastic strip is cooled in a cooler 22. Then the plastic strip is preferably conducted through a fourth stretcher 23 that works for instance with an advance speed of 85 m/min. Then the plastic strip is preferably wound in a winder (not shown). The inventively produced plastic strip has in particular optimum mechanical properties and can be used as high-quality packing tape.

I claim:

1. A method of making a packing tape comprising the steps of:
predrying polyethylene terephthalate and supplying it to a chamber of an extruder;
agglomerating and melting the polyethylene terephthalate in the extruder while moving it through the chamber in a travel direction;
applying negative pressure to the chamber of the extruder and thereby drawing low-molecular-weight impurities from the polyethylene terephthalate therein; and
extruding the melted polyethylene terephthalate as a strip from the extruder through a spinneret.

2. The method defined in claim 1 wherein the polyethylene terephthalate comprises at least 50 wt. % polyethylene terephthalate scrap.

3. The method defined in claim 2 wherein the polyethylene terephthalate scrap has a moisture content of less than 30 ppm.

4. The method defined in claim 1 wherein the negative pressure is less than 10 millibars.

5. The method defined in claim 1 wherein the negative pressure is applied in the extruder chamber at two location spaced apart in the travel direction.

6. The method defined in claim 5 wherein the extruder agglomerates the polyethylene terephthalate in an upstream zone to which the negative pressure is applied and then melts the polyethylene terephthalate in a downstream zone to which the negative pressure is also applied.

7. The method defined in claim wherein the low-molecular-weight impurities include glycol, 1,2-ethane diol, dioxolan, xylene, ethanol, terephthalic acid, isophthalic acid, acetaldehyde, or 2-propanol.

8. The method defined in claim 1, further comprising the steps of:
cooling and stretching the strip after extruding it from the spinneret.

9. An apparatus for making packing tape, the apparatus comprising:
an extruder having a chamber holding a screw and having an intake end and an opposite output end provided with a spinneret;
means for feeding predried polyethylene terephthalate to the intake end;
means for actuating the extruder and thereby agglomerating and melting the polyethylene terephthalate while moving it through the chamber in a travel direction and extruding the melted polyethylene terephthalate as a strip from the extruder through a spinneret; and
means for applying negative pressure to the chamber of the extruder and thereby drawing low-molecular-weight impurities from the polyethylene terephthalate therein.

10. The apparatus defined in claim 9 wherein the means for applying negative pressure includes a pair of vacuum domes connected to the extruder and opening into the chamber at locations spaced apart in the travel direction.

11. The apparatus defined in claim 9 wherein the extruder is a single-screw extruder.

12. The apparatus defined in claim 9 wherein the means for feeding includes means for supplying at least 50 wt. % scrap polyethylene terephthalate scrap to the intake end.
